(19) United States
(12) Patent Application Publication
(10) Pub. No.: US 2026/0286709 A1
(43) Pub. Date: Sep. 24, 2026

(54) Recessed Handrail and Method of Installation

(71) Applicant: Iron Baluster, LLC, Goshen, IN (US)

(72) Inventor: Graham Morris, New Paris, IN (US)

(73) Assignee: Iron Baluster, LLC, Goshen, IN (US)

(21) Appl. No.: 19/082,333

(22) Filed: Mar. 18, 2025

(51) Int. Cl. E04F 11/18; F21S 4/28; F21V 33/00

(52) U.S. Cl. CPC E04F 11/1804; F21S 4/28; F21V 33/006; E04F 2011/1872

(57) ABSTRACT

An inset handrail assembly is formed from an elongate extrusion that is secured to a building or other structure. The elongate extrusion has a first flange connected to a second flange through a cove wall. The framing of the structure has an installation gap that receives the cove wall and allows the first and second flanges to be secured. A handrail attaches to a saddle that extends from one of the flanges. The cove wall can receive a decorative cover, along with covers or alternate materials on the handrail for customization. The extrusion also includes a luminaire channel to receive a luminaire strip for accent illumination.

### BACKGROUND OF THE INVENTION

The present disclosure relates to handrails, particularly handrails that are flush or inset from the wall. Handrails are ubiquitous, particularly around walkways, stairs, balconies, and other spaces where user safety and stability are concerns. A typical handrail is affixed to a wall or other vertical surface and protrudes from the wall into the space. In contrast, a flush or inset handrail does not protrude from the wall, constructively forming a groove or channel where the handrail is integrated into that groove or channel. When an inset handrail is desired or required, these typically are built on-site, requiring fabrication that is either expensive or performed with less than ideal tools and conditions. Therefore, an improved inset handrail is needed that can be installed as an assembly.

### SUMMARY OF THE INVENTION

The present disclosure describes an inset handrail for being affixed to a structure. The inset handrail comprises an elongate extrusion having a lower attachment portion integrally connected to an upper attachment portion through a cove wall. The lower attachment portion has a bottom flange that extends to a handrail stem portion and terminates at a handrail saddle which includes a channel. The upper attachment portion has a top flange with a top framing-facing surface that is located on a framing plane. The bottom flange has a bottom framing-facing surface located on the same framing plane. The framing plane extends through the handrail saddle. A separate handrail has an outside surface that is complementary to the channel and can be affixed to the handrail saddle. With the handrail installed, the framing plane extends through the handrail. The elongate extrusion may also have a luminaire track that extends from the handrail stem portion. The luminaire track is formed from a first wall spaced from and parallel to a second wall and can receive an elongate luminaire strip. In addition, the first and second walls of the luminaire track may be angled with respect to the handrail stem portion. Optionally, the outside surface of the handrail is cylindrical and the channel in the handrail saddle is arcuate.

To install the inset handrail in a structure, the user starts with a structural wall and affixes offset framing to the structural wall. The offset framing has an installation gap, with an upper portion of the offset framing being above the installation gap and a lower portion of the offset framing being below the installation gap. The installation gap is sufficient to receive the cove wall with the top and bottom flanges overlaying upper and lower portions of the offset framing. Next, the user affixes the bottom flange to the lower portion of the offset framing that is adjacent the installation gap and the top flange to the upper portion of the offset framing that is adjacent the installation gap. Next, the user provides the handrail and secures it to the handrail saddle. The user then installs wallcovering to cover the top and bottom flanges. Optionally, the user covers the cove wall with a flexible decorative panel that is adhered to the cove wall.

### BRIEF DESCRIPTION OF THE DRAWINGS

FIG. 1 is an isometric view of the inset handrail as installed in a structure;

FIG. 2 is an isometric view of the installed inset handrail in FIG. 1 with the wall covering removed;

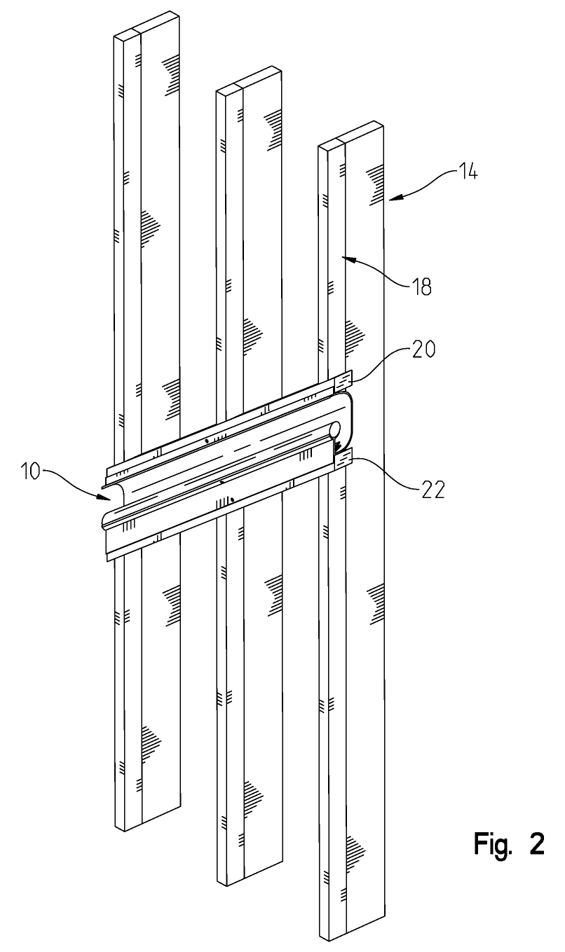

FIG. 3 is an isometric partially exploded view of the installed inset handrail in FIG. 1;

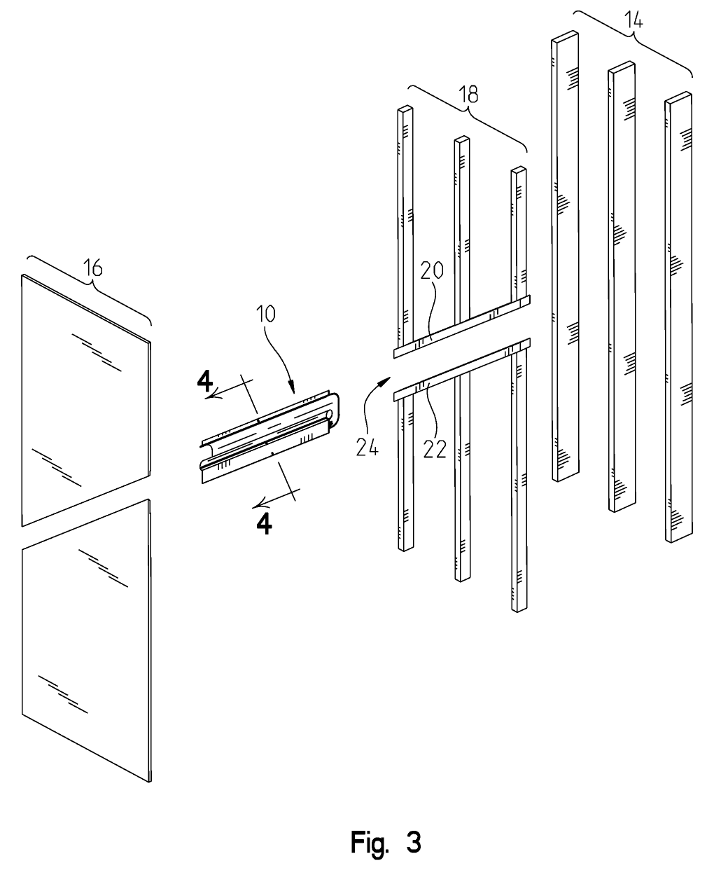

FIG. 4 is a section view 4-4 of the handrail in FIG. 3; and

FIG. 5 is a partial section view 5-5 of the installed handrail in FIG. 1.

### DESCRIPTION OF THE PREFERRED EMBODIMENT

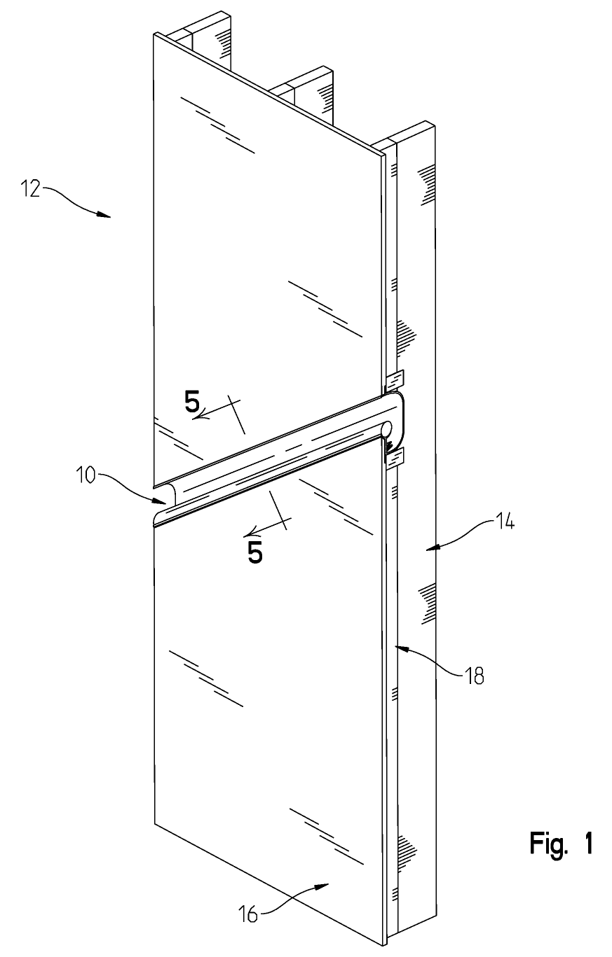

An inset handrail assembly 10 is shown in FIG. 1 as installed within a wall 12. The wall 12 has structural framing 14 and wallcovering 16. The framing 14 shown in this embodiment uses dimensional lumber commonly known as 2x6 spaced apart and secured to portions of the structure not shown herein, but other structures are contemplated, including steel, block, poured concrete, and/or other load-bearing or structural materials. To accommodate the handrail assembly 10, offset framing 18 is secured to the structural framing 14. The offset framing 18 includes an upper plate 20 and a lower plate 22 that are spaced from each other to form an installation gap 24. In the installation shown in this embodiment, the handrail assembly 10 is installed on an angle to follow a flight of stairs or stairway (not shown), but other installations are contemplated, including but not limited to a horizontal installation. In addition, one installation can include angled portions joined to horizontal portions to accommodate stairways with landings or continue the handrail at the end of stairs for safety or aesthetic reasons. In any event, the offset framing 18 must include an installation gap 24 to accommodate the handrail assembly 10, even if upper and lower plates 20, 22 are not used. The installation gap 24 has an upper boundary and a lower boundary where the framing resumes.

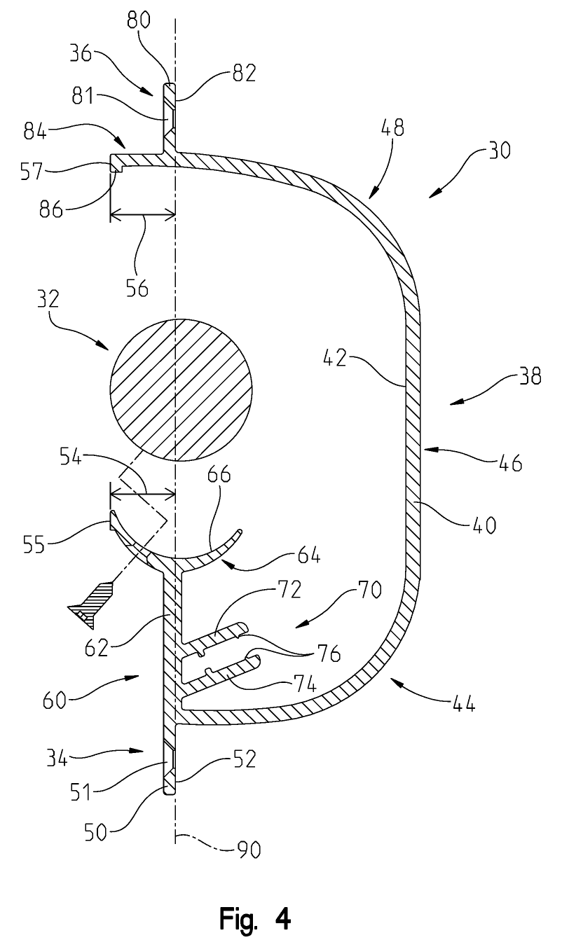

Turning now to the details of the handrail assembly 10, an enlarged cross-section view is shown in FIG. 4. The handrail assembly has two main components, an extrusion 30 and handrail 32. The extrusion 30 and handrail 32 are separate components in this embodiment, but it is contemplated that the handrail is integrated into the extrusion. The extrusion 30 as shown in the embodiment herein is a single unitary component with a consistent cross-sectional shape along its length, however it is contemplated that the extrusion 30 is an assembly of multiple extrusions. As will be described herein, the extrusion 30 has several portions: a lower attachment portion 34, an upper attachment portion 36, and a cove portion 38. The cove portion 38 is a C-shaped wall 40 that extends from and attaches the lower attachment portion 34 to the upper attachment portion 36. The C-shaped wall 40 has a lower curved portion 44 extending to a flat portion 46 that extends to an upper curved portion 48. The C-shaped wall 40 also has a cove surface 42 that can receive a decorative covering. It is contemplated that the C-shaped wall 40 instead includes only flat portions that more closely match the interior shape of the installation gap 24. The lower attachment portion 34 has a bottom flange 50 with a lower framing-facing surface 52 for contacting the offset framing 18 adjacent the lower boundary. The bottom flange 50 may also contain fastener apertures 51 for securing it to the offset framing 18. Extending from the lower attachment portion 34 toward the upper attachment portion 36 is a handrail stem portion 60. The handrail stem portion 60 has a stem wall 62 that terminates at a handrail saddle 64. The handrail saddle 64 has a channel 66 that matches the outside shape of the handrail 32. In the embodiment shown herein, the channel 66 is arcuate but other shapes are contemplated.

The stem wall 62 includes a luminaire track 70 that can receive an elongate luminaire, such as an LED strip 78. The luminaire track 70 includes a first wall 72 and a second wall 74 that are parallel to each other. The first and second walls 72, 74 include barbs 76 and other features to retain the luminaire. As shown, the first and second walls 72, 74 are obliquely angled with respect to the stem wall 62, but other angles are contemplated.

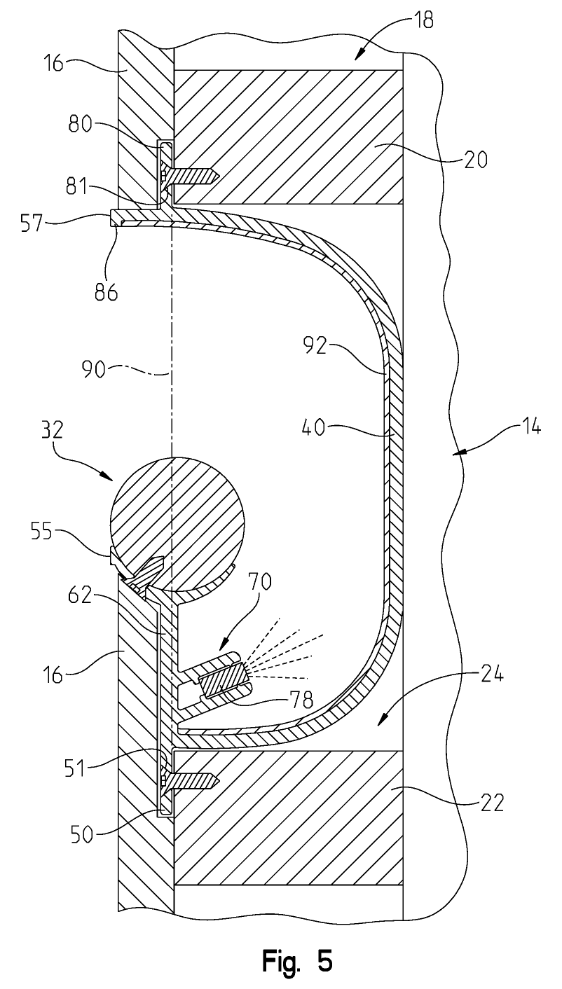

The upper attachment portion 36 includes a top flange 80 with an upper framing-facing surface 82 that also is for contacting the offset framing 18 adjacent the upper boundary. As with the bottom flange 50, the top flange 80 may include fastener apertures 81 for securing it to the offset framing 18. Both framing-facing surfaces 52, 82 define a framing plane 90 that extends through the handrail 32 and handrail saddle 64. For the purposes of identification and not limiting in any way, the framing plane 90 defines a boundary between an exterior region and an interior region. The exterior portion of the handrail saddle 64 extends outwardly by a first distance 54 and terminates at a lower exterior surface 55. The lower exterior surface 55 is parallel to the framing plane 90 and is visible between the handrail 32 and the upper edge of the wallcovering 16. As can be seen in FIG. 4, nearly all of the cove portion 38 is located in the interior side of the framing plane 90. Adjacent the top flange, an overhanging portion 84 of the C-shaped wall 40 and cove surface 42 extends beyond the framing plane 90. The cove surface 42 terminates at a cove panel retention stub wall 86 that extends in the exterior region by a second distance 56. The stub wall 86 terminates at an upper exterior surface 57 that is also parallel to the framing plane 90. The upper exterior surface 57 is visible below the lower edge of the wallcovering 16. In the embodiment shown herein, the first and second distances 54, 56 are the same. The stub wall 86 is sized to accommodate the thickness of a decorative cove panel 92, shown in FIG. 5.

To install the handrail assembly, the user determines the height and angle (if any) that is desired in the final installation and builds offset framing 18. The offset framing 18 is secured to the structural framing 14. The offset framing 18 can be built with the installation gap 24 or it could be cut just before installation of the extrusion 30. It is further contemplated that the offset framing 18 is omitted and the structural framing 14 is notched to create the installation gap 24, provided the installation gap does not compromise the structural framing 14. If the structural framing 14 is notched, structural reinforcing plates (not shown) may be necessary to restore any structural integrity lost by notching. The reinforcing plates may also include a complementary notch that is complementary to the notches in the structural framing 14. These are affixed with the complementary notches aligned on the sides, also called sistering. The installation gap 24 allows the cove portion 38 to be received and the framing-facing surfaces 52, 82 to contact the offset framing 18 or structure that is adjacent the installation gap. Fasteners are then secured through the top and bottom flanges 50, 80 to secure the extrusion 30 to the structure, shown in FIG. 5. If the installation includes angled and horizontal sections (not shown) for landings, balconies, or other transitions, the user miter cuts the ends of the extrusion 30 and repeats the installation steps previously disclosed for each section of the extrusion. The handrail 32 is then placed in the handrail saddle 64 and installed with fasteners. If needed, the handrail 32 is also miter cut where ends of the handrail meet each other. After the handrail 32 is secured, wallcovering 16 can be added that extends to the handrail saddle 64 on the bottom and the overhanging portion 84 on the top. The wallcovering 16 in the embodiment herein is drywall but other materials are contemplated, including stone, paneling, tile, laminate, plywood, veneered MDF, and wood. As can be seen in FIG. 5, the wallcovering 16 can be notched or otherwise modified to account for the thickness of the portions of the top and bottom flanges 50, 80, stem wall 62, and portions of the handrail saddle 64 that extend beyond the framing plane 90. As shown in FIG. 5, the decorative cove panel 92 can be applied over the entire cove surface 42. The decorative cove panel 92 can include any flexible sheet material that can be adhered to or overlay the cove surface 42. The cove panel retention stub wall 86 serves as one of the lateral boundaries to the cove panel 92, while the other lateral boundary is formed where the C-shaped wall 40 meets the stem wall 62.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. An inset handrail assembly for being affixed to a structure, said inset handrail comprising:
an elongate extrusion having a lower attachment portion connected to an upper attachment portion through a cove wall, said lower attachment portion having a bottom flange extending to a handrail stem portion and terminating at a handrail saddle, said upper attachment portion having a top flange, said top flange having a framing-facing surface being located on a framing plane, said bottom flange having a framing-facing surface located on said framing plane, said framing plane extends through said handrail saddle; and
a handrail having an outside surface complementary to said handrail saddle.

2. The inset handrail in claim 1, further comprising a luminaire track extending from said handrail stem portion, said luminaire track formed from a first wall spaced from and parallel to a second wall.

3. The inset handrail in claim 2, wherein said first and second walls of said luminaire track are obliquely angled with respect to said handrail stem portion.

4. The inset handrail in claim 1, wherein said outside surface of said handrail is cylindrical, said handrail saddle is an arcuate channel.

5. The inset handrail in claim 1, wherein a portion of said handrail saddle extends in a direction away from said cove wall and terminates at a first distance from said framing plane.

6. The inset handrail in claim 1, wherein said cove wall extends beyond said top flange and terminates at a second distance from said framing plane.

7. The inset handrail in claim 1, wherein a portion of said handrail saddle extends in an exterior direction and terminates at a first distance from said framing plane, said cove wall extends beyond said top flange and terminates at a second distance from said framing plane, said first and second distances are equal.

8. The inset handrail in claim 1, wherein said cove wall has a lower curved portion where it meets said lower attachment portion and an upper curved portion where it meets said upper attachment portion, said cove wall having a flat portion extending between said upper and lower curved portions.

9. An inset handrail for being affixed to a structure, said inset handrail comprising:
an elongate extrusion having a lower attachment portion connected to an upper attachment portion through a cove wall, said lower attachment portion having a bottom flange extending to a handrail stem portion and terminating at a handrail, said upper attachment portion having a top flange, said top flange having a framing-facing surface being located on a framing plane, said bottom flange having a framing-facing surface located on said framing plane, said framing plane extends through said handrail; and
a luminaire track extending from said handrail stem portion, said luminaire track formed from a first wall spaced from and parallel to a second wall.

10. The inset handrail in claim 9, wherein said first and second walls of said luminaire track are obliquely angled with respect to said handrail stem portion.

11. The inset handrail in claim 9, wherein said cove wall extends beyond where it intersects said top flange and terminates at a second distance from said framing plane.

12. The inset handrail in claim 9, wherein a portion of said handrail extends in an exterior direction and terminates at a first distance from said framing plane, said cove wall extends beyond where it intersects said top flange and terminates at a second distance from said framing plane, said first and second distances are equal.

13. The inset handrail in claim 9, wherein said cove wall has a lower curved portion where it meets said lower attachment portion and an upper curved portion where it meets said upper attachment portion, said cove wall having a flat portion extending between said upper and lower curved portions.

14. A method of installing an inset handrail comprising:
providing a structural wall;
providing an elongate extrusion having a lower attachment portion connected to an upper attachment portion through a cove wall, said lower attachment portion having a bottom flange extending to a handrail stem portion and terminating at a handrail saddle, said upper attachment portion having a top flange, said top flange having a framing-facing surface being located on a framing plane, said bottom flange having a framing-facing surface located on said framing plane, said framing plane extends through said handrail saddle;
providing an installation gap to receive said cove wall, said installation gap having an upper boundary and a lower boundary;
affixing said top flange adjacent said upper boundary of said installation gap;
affixing said bottom flange adjacent lower boundary of said installation gap;
providing a handrail having an outside surface complementary to said handrail saddle; and
affixing said handrail to said handrail saddle.

15. The method of claim 14, further providing offset framing, affixing said offset framing to said structural wall, said offset framing having said installation gap, an upper portion of said offset framing is above said installation gap, a lower portion of said offset framing is below said installation gap, affixing said top flange to said upper portion of said offset framing, affixing said bottom flange to said lower portion of said offset framing.

16. The method of claim 14, further providing reinforcing plates having a notch, notching said structural wall to form said installation gap, aligning said notch on said reinforcing plates to said notched structural wall, affixing said reinforcing plates to said structural wall.

17. The method of claim 14, further providing wallcovering, notching portions of said wallcovering that overlay said top flange and said bottom flange, affixing said wallcovering to overlay said top and bottom flanges.

18. The method of claim 14, further providing a cove panel, attaching said cove panel to overlay said cove wall.

19. The method of claim 14, wherein said elongate extrusion has a luminaire track, attaching an elongate luminaire in said luminaire track.

20. The method of claim 14, wherein said cove wall has a lower curved portion where it meets said lower attachment portion and an upper curved portion where it meets said upper attachment portion, said cove wall having a flat portion extending between said upper and lower curved portions.
